(19) United States
(12) Patent Application Publication
(10) Pub. No.: US 2025/0200075 A1
(43) Pub. Date: Jun. 19, 2025

(54) SYSTEM AND METHOD FOR MATCHING SYSTEM ENTITIES USING PRIORITIZED CONSTRAINTS

(71) Applicant: Axonius Solutions Ltd., Tel-Aviv (IL)

(72) Inventors: Oded Eliyahu SHIMON, Holon (IL); Eli SHAY, Harish (IL); Ben Shimon HAZOUT, Gan Yavne (IL)

(73) Assignee: Axonius Solutions Ltd., Tel-Aviv (IL)

(21) Appl. No.: 18/537,882

(22) Filed: Dec. 13, 2023

(51) Int. Cl. G06F 16/28; G06F 16/2455; H04L 61/2596

(52) U.S. Cl. CPC G06F 16/288; G06F 16/2455; H04L 61/2596

(57) ABSTRACT

A method for managing entities of a computerized system, comprising: generating from descriptors describing entities of a computerized system, updated descriptors, by: identifying in the descriptors records, each record describing an entity and associated with a descriptor describing the entity; and in each of a plurality of iterations, applying to the records a rule of a rule set of a prioritized set of rule sets, in descending order of priority of the prioritized set of rule sets, where in an iteration applying the rule comprises, for a first record describing a first entity and a second record describing a second entity: identifying an equivalence between the first entity and the second entity; identifying a conflict between a first descriptor associated with the first record and a second descriptor associated with the second record; and subject to failing to identify the conflict, merging the first descriptor and the second descriptor.

### FIELD AND BACKGROUND OF THE INVENTION

Some embodiments described in the present disclosure relate to infrastructure of a computerized system and, more specifically, but not exclusively, to a computerized system associated with a plurality of system management entities.

As use herein, the term “network connected device” refers to an entity connected to a digital communication network and having an identifier unique within a management domain. Some examples of a network-connected device are a computer, a network device, such as a router, and a virtual machine, executed by a host machine. Some additional examples of a network connected device are a computer peripheral device, such as a printer, a digital storage device, and a nonstandard computing device that connects to a network and has an ability to transmit data (commonly known as an Internet Of Things device), such as a thermostat, a light bulb controller, and an electrical switch. Some examples of a management domain are a device deployment domain and a security domain. For brevity, unless otherwise noted the term “device” is used herein to mean “network connected device” and the terms are used interchangeably.

As used here within, the term “user” refers to a person or computerized agent having an identifier unique within a user management domain. For example, a user may be an employee of the organization. Some example of a user management domain include a human resources management tool.

A computerized system comprises a plurality of entities. An entity may be a hardware component. An entity may be a software component. An entity may be a network-connected device. An entity may be a user. As used here within, the terms “asset” and “entity” each refer to a hardware component, software component or user of a computerized system and the terms are used interchangeably.

Currently, organizations use a variety of tools and services, henceforth referred to as “system management entities”, to manage their computerized system.

### SUMMARY OF THE INVENTION

Some embodiments described in the present disclosure provide a system and method for managing a plurality of entities of a computerized system by reducing an amount of duplications in a plurality of entity descriptors where each of the plurality of entity descriptors describes one of the plurality of entities of the computerized system. In such embodiments, one or more of the plurality of entity descriptors are correlated by applying to one or more records associated with the one or more entity descriptors and received from one or more system management entities a plurality of rules organized in a prioritized set of rule sets, applied in order of priority of the prioritized set of rule sets and where a rule may have a constraint. Organizing the plurality of rules in a prioritized set of rule sets, and applying the priority of rules in order of priority of the prioritized set of rule sets allows applying one or more constraints that apply to an entire rule set when correlating the one or more entity descriptors in order of priority. This provides more flexibility in applying the one or more constraints, and thus more accuracy in the resulting correlation between the one or more entity descriptors, than applying a strict priority among the plurality of rules when organized in one set of rules.

The foregoing and other objects are achieved by the features of the independent claims. Further implementation forms are apparent from the dependent claims, the description and the figures.

According to a first aspect, a method for managing a plurality of entities of a computerized system comprises: generating from a plurality of entity descriptors, each describing one of a plurality of entities of a computerized system, an updated plurality of entity descriptors, by: identifying in the plurality of entity descriptors a plurality of records retrieved from at least one system management entity managing the computerized system, each record describing an entity of the plurality of entities and associated with one of the plurality of entity descriptors describing the entity; and in each of a plurality of iterations, applying to the plurality of records a rule of a rule set of a prioritized set of rule sets, in descending order of priority of the prioritized set of rule sets, where in at least one iteration of the plurality of iterations the rule comprises a correlation test and a conflict test and applying the rule in the at least one iteration comprises, for a first record of the plurality of records, describing a first entity of the plurality of entities, and a second record of the plurality of records, describing a second entity of the plurality of entities: identifying an equivalence between the first entity and the second entity according to an outcome of applying the correlation test of the rule to a first plurality of values of the first record and a second plurality of values of the second record; identifying a conflict between at least one first entity value of a first entity descriptor associated with the first record and at least one second entity value of a second entity descriptor associated with the second record according to another outcome of applying the conflict test of the rule to a first plurality of entity values of the first entity descriptor and a second plurality of entity values of the second entity descriptor; and subject to failing to identify the conflict, merging the first entity descriptor and the second entity descriptor, otherwise declining to perform the merge; and providing the updated plurality of entity descriptors to at least one management software object for the purpose of performing at least one management operation.

According to a second aspect, a system for managing a plurality of entities of a computerized system comprises at least one hardware processor configured to: generate from a plurality of entity descriptors, each describing one of a plurality of entities of a computerized system, an updated plurality of entity descriptors, by: identifying in the plurality of entity descriptors a plurality of records retrieved from at least one system management entity managing the computerized system, each record describing an entity of the plurality of entities and associated with one of the plurality of entity descriptors describing the entity; and in each of a plurality of iterations, applying to the plurality of records a rule of a rule set of a prioritized set of rule sets, in descending order of priority of the prioritized set of rule sets, where in at least one iteration of the plurality of iterations the rule comprises a correlation test and a conflict test and applying the rule in the at least one iteration comprises, for a first record of the plurality of records, describing a first entity of the plurality of entities, and a second record of the plurality of records, describing a second entity of the plurality of entities: identifying an equivalence between the first entity and the second entity according to an outcome of applying the correlation test of the rule to a first plurality of values of the first record and a second plurality of values of the second record; identifying a conflict between at least one first entity value of a first entity descriptor associated with the first record and at least one second entity value of a second entity descriptor associated with the second record according to another outcome of applying the conflict test of the rule to a first plurality of entity values of the first entity descriptor and a second plurality of entity values of the second entity descriptor; and subject to failing to identify the conflict, merging the first entity descriptor and the second entity descriptor, otherwise declining to perform the merge; and provide the updated plurality of entity descriptors to at least one management software object for the purpose of performing at least one management operation.

According to a third aspect, a software program product for managing a plurality of entities of a computerized system comprises: a non-transitory computer readable storage medium; first program instructions for generating from a plurality of entity descriptors, each describing one of a plurality of entities of a computerized system, an updated plurality of entity descriptors, by: identifying in the plurality of entity descriptors a plurality of records retrieved from at least one system management entity managing the computerized system, each record describing an entity of the plurality of entities and associated with one of the plurality of entity descriptors describing the entity; and in each of a plurality of iterations, applying to the plurality of records a rule of a rule set of a prioritized set of rule sets, in descending order of priority of the prioritized set of rule sets, where in at least one iteration of the plurality of iterations the rule comprises a correlation test and a conflict test and applying the rule in the at least one iteration comprises, for a first record of the plurality of records, describing a first entity of the plurality of entities, and a second record of the plurality of records, describing a second entity of the plurality of entities: identifying an equivalence between the first entity and the second entity according to an outcome of applying the correlation test of the rule to a first plurality of values of the first record and a second plurality of values of the second record; identifying a conflict between at least one first entity value of a first entity descriptor associated with the first record and at least one second entity value of a second entity descriptor associated with the second record according to another outcome of applying the conflict test of the rule to a first plurality of entity values of the first entity descriptor and a second plurality of entity values of the second entity descriptor; and subject to failing to identify the conflict, merging the first entity descriptor and the second entity descriptor, otherwise declining to perform the merge; and second program instructions for providing the updated plurality of entity descriptors to at least one management software object for the purpose of performing at least one management operation. The first and second program instructions are executed by at least one computerized processor from the non-transitory computer readable storage medium.

With reference to the first, second and third aspects, in a first possible implementation of the first, second and third aspects the first entity descriptor has a first state descriptor associated therewith, comprising a first plurality of state values that are members of the first plurality of entity values; the second entity descriptor has a second state descriptor associated therewith, comprising a second plurality of state values that are members of the second plurality of entity values; and applying the conflict test of the rule to the first plurality of entity values and the second plurality of values is by applying the conflict test of the rule to the first plurality of state values and the second plurality of state values. Applying the conflict test to state values increases accuracy of identifying a conflict, by focusing on entity values that are significant to uniquely identifying an entity. Optionally, merging the first entity descriptor and the second entity descriptor comprises merging the first state descriptor and the second state descriptor. Merging the first state descriptor and the second state descriptor reduces an amount of computation needed to merge the first state descriptor and the second state descriptor compared to merging the entire first state descriptor and the second state descriptor.

With reference to the first, second and third aspects, in a second possible implementation of the first, second and third aspects the method further comprises: receiving a new plurality of records from the at least one system management entity; adding the new plurality of records to the plurality of records; and for at least one new record of the new plurality of records: generating a new entity descriptor, associated with the at least one new record; and adding the new entity descriptor to the plurality of entity descriptors. Generating a new entity descriptor and adding the new entity descriptor to the plurality of entity descriptors allows continuous updating of the plurality of descriptors, as new records are received from the one or more system management entities.

With reference to the first, second and third aspects, in a third possible implementation of the first, second and third aspects applying the rule to the plurality of records comprises: in each of a plurality of other iterations: selecting another first record and another second record from the plurality of records; computing a first outcome value by applying the correlation test of the rule to another first plurality of values of the first record and another second plurality of values of the second record; and subject to identifying the equivalence between the first entity and the second entity, computing a second outcome value by applying the conflict test of the rule to another first plurality of entity values of another first entity descriptor associated with the other first record and another second plurality of entity values of another second entity descriptor associated with the other second record. Repeating application of the rule to pairs of records allows detecting more than one correlation between two entity descriptors, increasing accuracy of the updated plurality of entity descriptors. This increases accuracy of a management operation performed using the updated plurality of entity descriptors, for example reduces an amount of times a management operation is performed on a device of the computerized system.

With reference to the first, second and third aspects, in a fourth possible implementation of the first, second and third aspects each of the plurality of entity descriptors comprises a plurality of entity values, each for one of a plurality of entity attributes. Optionally, the first plurality of entity values are at least some of the plurality of entity values of the first entity descriptor, the second plurality of entity values are at least some of the plurality of entity values of the second entity descriptor, each of the plurality of records comprises a plurality of record values, each for one of the plurality of entity attributes, the first plurality of values are at least some of the plurality of record values of the first record, and the second plurality of values are at least some of the plurality of record values of the second records. Optionally, the plurality of entities comprises a plurality of devices; and the plurality of entity attributes comprises at least one of: a serial number of a device of the plurality of devices, a host-name of a device of the plurality of devices, a media access control (MAC) address of a device of the plurality of devices, an internet protocol (IP) address of a device of the plurality of devices, a cloud identifier of a device of the plurality of devices, a universally unique identifier (UUID) of a device of the plurality of devices, and an operating system of a device of the plurality of devices. Optionally, the correlation test comprises at least one value of a MAC address of a device and the conflict test comprises at least one other value of a serial number of a device. Applying the correlation test to one or more values of a MAC address of a device and the conflict test to one or more other values of a serial number of a device allow applying a constraint of a device having a single serial number even when more than one device share a common MAC address. Optionally, the correlation test comprises at least one first value of a MAC address of a device and at least one second value of a host-name of a device, and the conflict test comprises at least one third value of a cloud identifier of a device. Applying the correlation test to one or more values of a MAC address of a device and one or more values of a host-name of a device, and applying the conflict test to one or more other values of a cloud identifier of a device allow applying a constraint of a device having a single cloud identifier even when more than one device share a common MAC address and a common host-name. Optionally, the correlation test comprises at least one value of a UUID of a device and the conflict test comprises at least one other value of a cloud identifier of a device. Applying the correlation test to one or more values of a UUID a device and the conflict test to one or more other values of a cloud identifier of a device allow applying a constraint of a device having a single cloud identifier even when more than one device share a common UUID, for example clones of a virtual machine. Optionally, the plurality of entities comprises a plurality of users. Optionally, the plurality of entity attributes comprises at least one of: a username of a user of the plurality of users, an electronic mail address of a user of the plurality of users, a state identifier of a user of the plurality of users, a user domain identification number of a user of the plurality of users, and an employee identification number of a user of the plurality of users. Optionally, the correlation test comprises at least one value of an electronic mail address of a user and the conflict test comprises at least one other value of a state identifier of a user. Applying the correlation test to one or more values of electronic mail address of a user and the conflict test to a state identifier of a user allow applying a constraint of a user living in a single state even when more than one user share a common electronic mail address. Optionally, the correlation test comprises at least one value of an electronic mail address of a user and the conflict test comprises at least one other value of a user domain identification number of a user. Applying the correlation test to one or more values of electronic mail address of a user and the conflict test to a user domain identification number of a user allow applying a constraint of a user having a single identification in a user domain when more than one user share a common electronic mail address.

With reference to the first, second and third aspects, in a fifth possible implementation of the first, second and third aspects the at least one management operation comprises at least one of: installing an operating system update on one of the plurality of entities, and instructing execution of a management query by one of the plurality of entities.

With reference to the first, second and third aspects, in a sixth possible implementation of the first, second and third aspects the system further comprises at least one digital communication network interface connected to the at least one hardware processor and the at least one hardware processor is configured to receive at least some of the plurality of records via the at least one digital communication network interface. Optionally, the at least one system management entity comprises at least one other hardware processor configured to manage the computerized system in at least one management domain and the at least one hardware processor is further configured to receive at least some of the plurality of records from the at least one other hardware processor. Optionally, the system further comprises a non-volatile digital storage connected to the at least one hardware processor and the at least one hardware processor is further configured to retrieve at least some of the plurality of records from the non-volatile digital storage.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which embodiments pertain. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

In the drawings:

FIG. 1 is a schematic block diagram of an exemplary system, according to some embodiments;

FIG. 2 is a flowchart schematically representing an optional flow of operations for managing a plurality of entities, according to some embodiments;

FIG. 3 is a flowchart schematically representing an optional flow of operations for generating an updated plurality of entity descriptors, according to some embodiments;

FIG. 4A is a schematic block diagram of an exemplary plurality of descriptors, according to some embodiments;

FIG. 4B is a schematic block diagram of an exemplary prioritized set of rule sets, according to some embodiments;

FIG. 5 is a schematic block diagram of another exemplary plurality of descriptors, according to some embodiments;

FIG. 6 is a schematic block diagram of an exemplary updated plurality of descriptors, according to some embodiments;

FIG. 7 is a flowchart schematically representing another optional flow of operations for generating an updated plurality of entity descriptors, according to some embodiments; and

FIG. 8 is a schematic block diagram of yet another exemplary plurality of descriptors, according to some embodiments.

### DESCRIPTION OF SPECIFIC EMBODIMENTS OF THE INVENTION

For brevity, unless otherwise noted henceforth the term “system” is used to mean “computerized system” and the terms are used interchangeably.

When managing a computerized system, there may be a need to identify unique devices and users in the system. Identifying a plurality of unique entity in a plurality of entities of a system and eliminating duplicate entities may reduce cost of operation of managing the plurality of entities, for example by reducing an amount of storage required to store data regarding the plurality of entities. For entities that are devices, identifying unique entities allows reducing an amount of power and/or an amount of time and/or an amount of computation resources required to perform a management operation on each of the plurality of entities by reducing an amount of times the management operation is executed on a single device. An example of a management operation is installation of an operating system update or execution of a management query. In addition, reducing an amount of times the management operation is executed on the single device may reduce a negative impact on an amount of resources of the single device and/or stability of the single device as it may be the case that executing a management operation more than once has one or more undesirable side effects on the single device. Some examples of an undesirable side effect are consuming additional resources, such as storage, with no functional advantage, and rendering some operation parameters of the single device inconsistent.

An entity in the system may have one or more attributes whose value may uniquely identify the entity. Historically, a computerized system of an organization was made up of hardware and software components owned by the organization and installed on-premises, with identified users of the organization. In such systems, an organization may have tight control over managing the system's entities, so for example computer names may be guaranteed to be unique. Nowadays, however, there is increasing prevalence of computerized systems where at times some users connect to the system via a remote network connection. In such cases, a device used by a user may be owned by the user and not by the organization. In addition, a hardware device on-premises, for example a docking station or a conference audio device, may be used at different times by different users and connected at different times to different computing devices, such as laptops. As a result, attributes that previously may have been used to identify a device, for example a media access control (MAC) address or a computer name for a hardware device, might no longer be unique identifiers of a device, for example two user owned devices that have a common computer name or a MAC address of a conference audio device that is associated with both the conference audio device and a laptop connected to it, possibly a different laptop at different times. In another example, when an organization includes multiple sub-organizations with separate employee management systems, different employees may share a common employee identification number in different employee management systems.

In addition, management of current computerized systems includes use of more than one system management entity. For example, management of a system may include services provided by one or more of Amazon Web Services (AWS), Microsoft Azure and VmWare ESXi for deploying, executing and serving one or more virtual machines of the system. In another example, a system management entity may provide one or more security services to a device in the system, for example McAffee ePolicy Orchestrator (ePO) and Microsoft Active Directory. A device may be associated with one or more management domains, for example a virtual machine may be deployed and executed by AWS and domain security services for the device may be provided by Microsoft Active Directory. In another example, a device may be associated with one or more security domains. Other examples of system management services include ServiceNow and Okta.

Management of a system may include collecting information from more than one system management entities that provide management services to the system. To identify unique entities in the system, there is a need to correlate information collected from the more than one system management entities. There exist attributes whose values uniquely identify an entity, for example a person's government issued identifier number in a given country uniquely identifies a person, a Basic Input/Output System (BIOS) serial identifier for a computer or an International Mobile Equipment Identity (IMEI) value for a mobile device. However, not all system management entities have access to all such values. It is common practice for an entity to have a domain entity identifier, uniquely identifying the entity with a management domain. When an entity is associated with a plurality of management domains, the entity may have a plurality of domain entity identifiers, each associated with one of the plurality of management domains.

We can distinguish between “strong identifiers” that have a high likelihood of uniquely identifying an entity, and “weak identifiers” that have a lower likelihood of uniquely identifying the entity. Some examples of a strong identifier include a BIOS serial identifier, an IMEI value, a government identification number. Some examples of a weak identifier include a MAC address, a computer name and an employee name.

It is common practice to use a set of correlation rules when correlating information from one or more system management entities. Accessing one or more sets of records received from the one or more system management entities, the set of correlation rules is applied to pairs of records. When information is available about a strong identifier, two or more records may be correlated based on a strong identifier. Otherwise, the two or more records may be correlated based on a weak identifier. A more robust approach would be to correlate the two or more records based on a weak identifier so long as there is no contradiction between values of a strong identifier.

While this approach may reduce an amount of false correlations (referred to as “over-correlations”, this approach is still limited. For example, over-correlation is still possible when information is unavailable about a strong identifier when comparing two records. For example, two laptops sharing a computer name or associated with a common MAC address of a docking station may be correlated when BIOS serial identifier information is unavailable in one or more of the two records. In another example, when the records do not include information about a virtual machine's Cloud Identifier, two virtual machines sharing a common universally unique identifier (UUID) may be correlated even though they have different Cloud Identifiers.

To improve accuracy of identifying unique entities, the present disclosure is some embodiments described here within proposes organizing a plurality of rules for correlating information from one or more management system entities in a prioritized set of rule sets, and maintaining a global state for an entity based on accumulated correlation information.

In such embodiments, the present disclosure proposes identifying in a plurality of entity descriptors a plurality of records retrieved from one or more system management entities managing the system, where each of the plurality of entity descriptors describes one of a plurality of entities of a computerized system, and where each record of the plurality of records describes an entity of the plurality of entities and is associated with an entity descriptor of the plurality of entity descriptors describing the entity described by the record. Furthermore, in such embodiments the present disclosure proposes applying to the plurality of records in each of a plurality of iterations a rule of a rule set, in order of priority of the prioritized set of rule sets. Optionally, in at least one iteration of the plurality of iterations, the rule comprises a correlation test and a constraint test, and in the at least one iteration the correlation test is applied to a first record describing a first entity of the plurality of entities and to a second record describing a second entity of the plurality of entities, and the constraint test is applied to a first entity descriptor associated with the first record and a second entity descriptor associated with the second record. Optionally, a first state descriptor is associated with the first entity descriptor, a second state descriptor is associated with the second entity descriptor, and the constraint test is applied to the first state descriptor and the second state descriptor. Optionally, an equivalence is identified between the first entity and the second entity according to an outcome of applying the correlation test of the rule to the first record and the second record. Optionally, according to an outcome of applying the conflict test to the first entity descriptor and the second entity descriptor (or the first state descriptor and the second state descriptor) a conflict is identified. When no conflict is identified, the present disclosure proposes in such embodiments merging the first entity descriptor and the second entity descriptor. Additionally or alternatively, when no conflict is identified, the present disclosure proposes in such embodiments merging the first state descriptor and the second state descriptor. However, when the conflict is identified, the present disclosure proposes, in such embodiments, declining to perform the merge.

As described above, in such embodiments an ongoing correlation state is maintained throughout the plurality of iterations for each of the plurality of entities, either in the entity descriptor describing the entity or in an associated state descriptor. Maintaining an ongoing correlation state throughout the plurality of iterations, and applying the conflict test to a first ongoing state of the first entity and a second ongoing state of the second entity, increases the likelihood of identifying when the first entity and the second entity are not the same entity and reduces the likelihood of falsely correlating the first entity with the second entity. This increases accuracy of the plurality of entity descriptors describing the plurality of entities of the system and thus increases accuracy of one or more management operations performed in the system using the plurality of entity descriptors. Applying the plurality of rules in priority order of the prioritized set of rule sets increases accuracy of the ongoing state that is maintained for each of the plurality of entities, thus ultimately increasing accuracy of the plurality of entity descriptors as described above.

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments or of being practiced or carried out in various ways.

Embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code, natively compiled or compiled just-in-time (JIT), written in any combination of one or more programming languages, including an object oriented programming language such as Smalltalk, C++, Java, Object-Oriented Fortran or the like, an interpreted programming language such as JavaScript, Python or the like, and conventional procedural programming languages, such as the “C” programming language, Fortran, or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), a coarse-grained reconfigurable architecture (CGRA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may be executed, in fact, substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

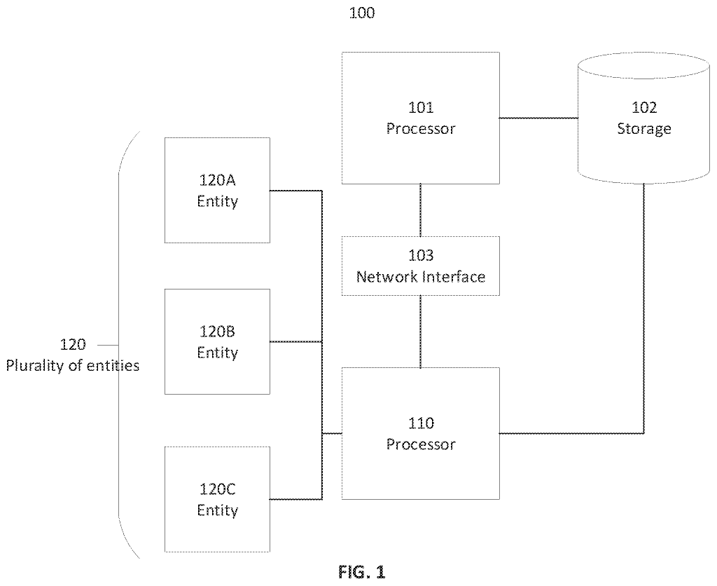

Reference is now made to FIG. 1, showing a schematic block diagram of an exemplary system 100, according to some embodiments. In such embodiments, at least one hardware processor 101 is connected to at least one digital communication network interface 103, optionally for communicating with at least one other hardware processor 110.

For brevity, henceforth the term “processing unit” is used to mean “at least one hardware processor” and the terms are used interchangeably. A processing unit may be any kind of programmable or non-programmable circuitry that is configured to carry out the operations described above/below. The processing unit may comprise hardware as well as software. For example, the processing unit may comprise one or more processors and a transitory or non-transitory memory that carries a program that causes the processing unit to perform the respective operations when the program is executed by the one or more processors.

In addition, for brevity henceforth the term “network interface” is used to mean “at least one digital communication network interface” and the terms are used interchangeably. Optionally, network interface 103 is connected to a local area network (LAN), for example an Ethernet network or a Wi-Fi network. Optionally, network interface 103 is connected to a wide area network (WAN), for example a cellular network or the Internet.

Optionally, system 100 comprises plurality of entities 120, for example comprising entity 120A, entity 120B and entity 120C. Optionally, entity 120A, entity 120B and entity 120C are each a device, connected to processing unit 101 and additionally or alternatively to other processing unit 110. Optionally, plurality of entities 120 comprises additionally or alternatively one or more entities that are users of system 100 (not shown). Optionally, processing unit 101 accesses a plurality of records, each record describing an entity of plurality of entities 120. Optionally, other processing unit 110 is configured to manage system 100 in one or more management domains, optionally executing one or more system management entities. Optionally, processing unit 101 receives at least some of the plurality of records from other processing unit 110. Optionally, processing unit 101 receives at least some of the plurality of records from one or more system management entities executed by processing unit 101 (via an inter-process communication channel, for example). Optionally, processing unit 101 retrieves at least some of the plurality of records from one or more digital storage 102. Optionally, other processing unit 110 stores at least some of the plurality of records on one or more digital storage 102. Optionally, one or more digital storage 102 is a non-volatile digital storage. Some examples of a non-volatile digital storage include a hard disk drive, a solid-state drive (SSD), a network connected storage and a storage network. Optionally one or more digital storage 102 is electrically connected to processing unit 101, for example when one or more digital storage 102 is a hard disk drive or a solid-state drive. Optionally, one or more digital storage 102 is connected to processing unit 101 via network interface 103, for example when one or more digital storage 102 is a storage network or a network attached storage.

To manage system the plurality of entities 120, system 100 in some embodiments described here within system 100 implements the following optional method.

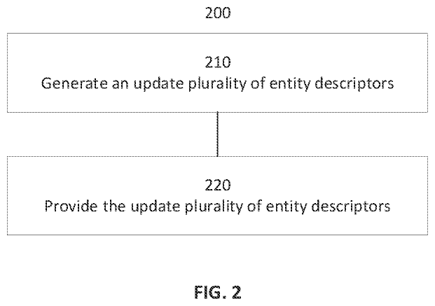

Reference is now made also to FIG. 2, showing a flowchart schematically representing an optional flow of operations 200 for managing a plurality of entities, according to some embodiments. In such embodiments, in 210 processing unit 101 generates an updated plurality of descriptors and in 220 processing unit 101 optionally provides the updated plurality of descriptors to one or more management software objects for the purpose of performing one or more management operations. Some examples of a management operation include, but are not limited to, installing an operating system update on one of the plurality of entities 120 and instructing execution of a management query by one of the plurality of entities 120. An example of a management query is a query of a management domain, for example a request for a status report or a request for a domain identifier. Optionally, the one or more management software objects are executed by processing unit 101. Optionally, the one or more management software objects are executed by other processing unit 110. Optionally, the one or more management software objects are executed by yet another processing unit (not shown), connected to the processing unit 101.

Optionally, in 210 the processing unit 101 generates the updated plurality of descriptors from a plurality of entity descriptors, where each of the plurality of entity descriptors describes one of the plurality of entities 120.

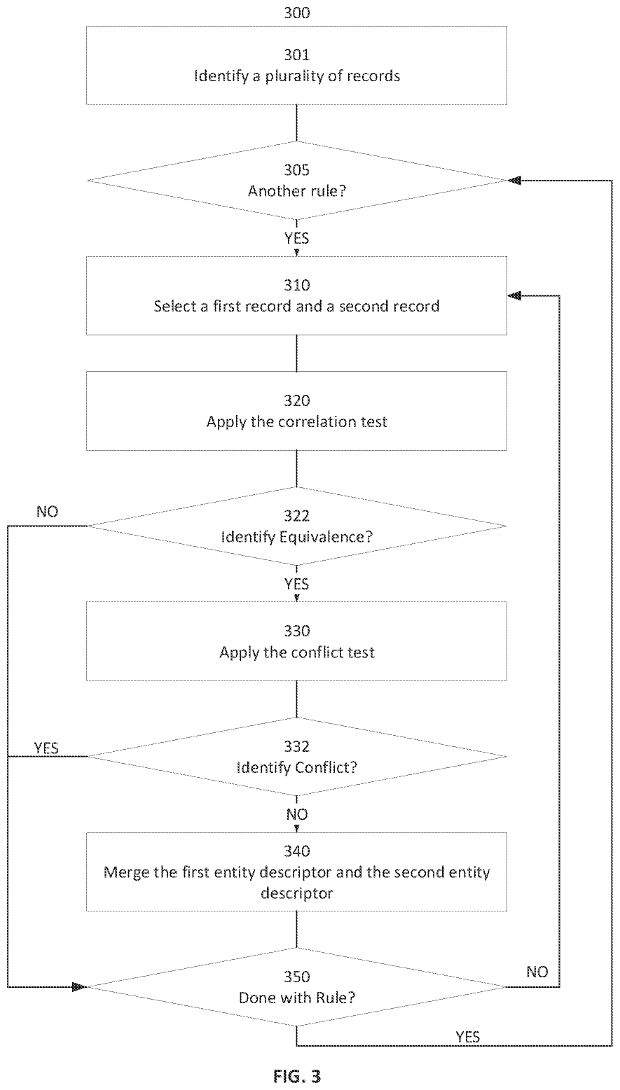

Reference is now made also to FIG. 3, showing a flowchart schematically representing an optional flow of operations 300 for generating an updated plurality of entity descriptors, according to some embodiments. In 301, the processing unit 101 optionally identifies in the plurality of entity descriptors a plurality of records, where each record of the plurality of records describes an entity of the plurality of entities 120 and is associated with one of the plurality of entity descriptors that describes the entity. Optionally, the plurality of records is retrieved from one or more system management entities managing system 100, for example executed by other processing unit 110. Optionally, at least some of the plurality of records are received via network interface 103. Optionally, at least some other of the plurality of records are retrieved from one or more digital storage 102.

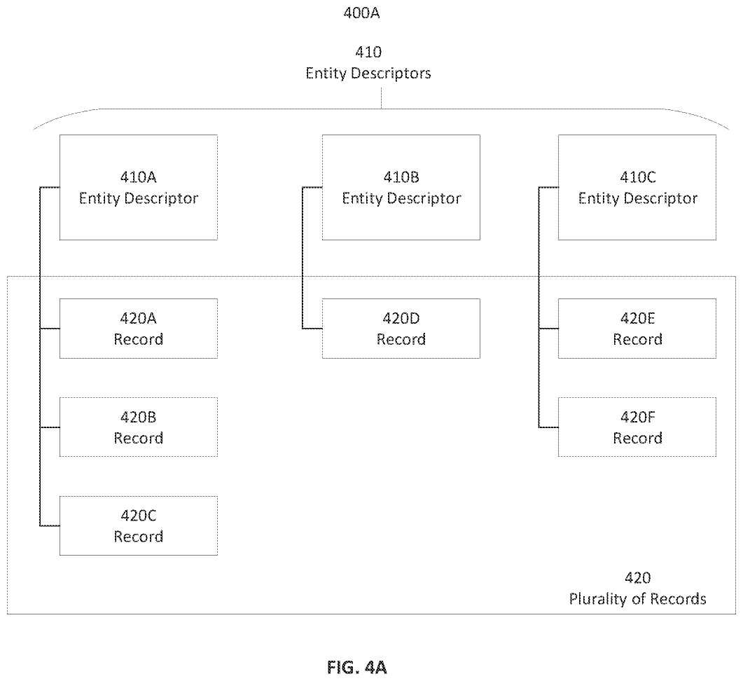

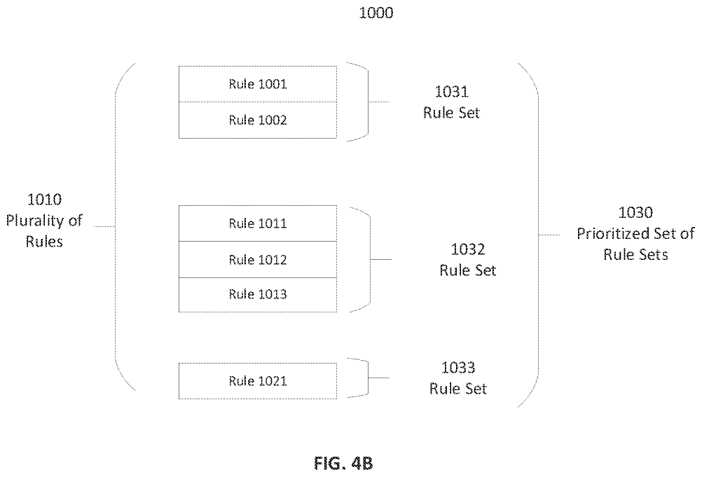

Reference is now made also to FIG. 4A, showing a schematic block diagram of an exemplary plurality of descriptors 400, according to some embodiments. In such embodiments, plurality of entity descriptors 410 comprises entity descriptor 410A, entity descriptor 410B and entity descriptor 410C. Optionally, each of the plurality of entity descriptors 410 describes one of the plurality of entities 120, for example entity descriptor 410A may describe entity 120.

Optionally, plurality of records 420 comprises record 420A, record 420B, record 420C, record 420D, record 420E and record 420F. Optionally, each of the plurality of records 420 is associated with one of the plurality of entity descriptors 410. For example, record 420A, record 420B and record 420C may be associated with entity descriptor 410A, describing entity 120A. Further in this example, record 420D may be associated with entity descriptor 410B and record 420E and record 420F may be associated with entity descriptor 410C. Optionally, entity descriptor 410B describes entity 120A, in addition to entity descriptor 410A describing entity 120A. Optionally entity descriptor 410C describes entity 120C.

Optionally, each of the plurality of records 420 comprises a plurality of record values, each for one of a plurality of entity attributes. When the plurality of entities 120 comprises a plurality of devices and the entity of the plurality of entities 120 described by a record is a device of the plurality of devices 120, some examples of an entity attribute include, but are not limited to, a serial number of the device, a host-name of the device, MAC address of the device, an internet protocol (IP) address of the device, a cloud identifier of the device, a UUID of the device, and an operating system of the device. When the plurality of entities comprises a plurality of users and the entity described by the record is a user of the plurality of users, some other examples of an entity attribute include, but are not limited to, a username of the user, an electronic mail address of the user, a state identifier of the user, a user domain identification number of the user, and an employee identification number of the user.

Optionally, each of the plurality of entity descriptors 410 comprises a plurality of entity values, each for one of the plurality of entity attributes.

Reference is now made also to FIG. 4B, showing a schematic block diagram of an exemplary prioritized set of rule sets 1000, according to some embodiments. In such embodiments, plurality of rules 1010 comprises rule 1001, rule 1002, rule 1011, rule 1012, rule 1013 and rule 1021. Optionally, the plurality of rules 1010 is organized in a prioritized set of rule sets 1030, comprising rule set 1031, rule set 1032 and rule set 1033. In this example, rule set 1031 has a higher priority than rule set 1032. Optionally, rule set 1032 has a higher priority than rule set 1033. Further, in this example, rule set 1031 comprises rule 1001 and rule 1002, rule set 1032 comprises rule 1011, rule 1012 and rule 1013, and rule set 1033 comprises rule 1021. Optionally a rule set consists of one rule.

Reference is now made again to FIG. 3. Optionally, the processor unit 101 executes a plurality of iterations, where in each iteration processor unit 101 applies to the plurality of records 420, a rule of a rule set of prioritized set of rule sets 1030, in order of priority of prioritized set of rule sets 1030. Optionally, processor unit 101 applies the plurality of rules in descending order of priority of priorities set of rule sets 1030. Referring again to FIG. 4B, in this example processing unit 101 applies to the plurality of records 420 in a plurality iterations first the one or more rules of rule set 1031, next the one or more rules of rule set 1032 and finally the one or more rules of rule set 1033. When applying the one or more rules of rule set 1031 there may not be a pre-defined order between rule 1001 and rule 1002. Similarly, there may not be a pre-defined order among rule 1011, rule 1012 and rule 1013 of rule set 1032. However, as in this example rule set 1031 has a higher priority than rule set 1032, processing unit 101 applies in this example both rule 1001 and rule 1002 before applying any of rule 1011, rule 1012 and rule 1013 of rule set 1032 and rule 1021 of rule set 1033. Similarly, in this example the processing unit 101 applies rule 1011, rule 1012 and rule 1013 before applying rule 1021 of rule set 1033.

Reference is now made again to FIG. 3. Optionally, in 305 processing unit 101 determines whether there is a rule to apply. Upon determining there is a rule to apply, processing unit 101 optionally executes a plurality of other iterations, optionally iterating on pairs of records of the plurality of records 420.

In 310 processing unit 101 optionally selects a first record and a second record from the plurality of records. Optionally, the first record and the second record are selected such that in the plurality of other iterations the rule is applied to all possible pairs of records of the plurality of records, for example by selecting the first record and then in each of some of the plurality of other iterations selecting another of the plurality of records as the second record. Optionally, processing unit 101 uses a heuristic function to select the first record and the second record. It should be noted that in this example a rule applied in an early iteration of the plurality of iterations is not applied again in another iteration of the plurality of iterations, after another lower priority rule is applied.

Optionally, the rule comprises a correlation test and a conflict test. Optionally, applying the rule to the first record and the second record comprises applying in 320 the correlation test of the rule to a first plurality of values of the first record and a second plurality of values of the second record. Optionally, the first plurality of values include at least some of the plurality of record values of the first record. Optionally, the first plurality of values are at least some of the plurality of record values of the first record. Optionally, the second plurality of values include at least some of the plurality of record values of the second record. Optionally, the second plurality of values are at least some of the plurality of record values of the second record.

Optionally, the first record describes a first entity of plurality of entities 120, for example record 420A describing entity 120A. Optionally, the second record describes a second entity of the plurality of entities 120, for example record 420D associated with entity descriptor 410B and describing entity 120A. Optionally, in 322 the processing unit 101 identifies an equivalence between the first entity and the second entity (as both are entity 120A) according to an outcome of applying the correlation test in 320.

Optionally, applying the rule to the first record and the second record comprises the processing unit 101 applying in 330 the conflict test of the rule to a first plurality of entity values of entity descriptor 410A that is associated with record 420A and a second plurality of entity values of entity descriptor 410B that is associated with record 420D.

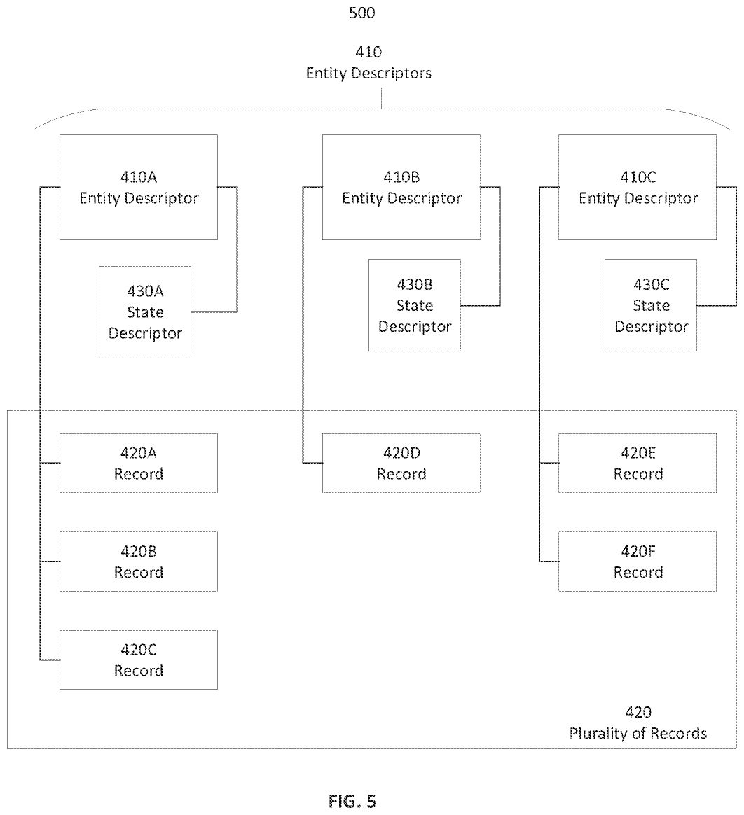

Optionally, each of the plurality of entity descriptors 420 has a state descriptor associated therewith. Reference is now made also to FIG. 5, showing a schematic block diagram of another exemplary plurality of descriptors 500, according to some embodiments. Optionally, a state descriptor comprises a plurality of state values that are members of the plurality of entity values of the entity descriptor associated therewith. In this example, state descriptor 430A is associated with entity descriptor 410A, state descriptor 430B is associated with entity descriptor 410B and state descriptor 430C is associated with entity descriptor 410C. Optionally in 320, processing unit 101 applies the conflict test to a first plurality of state values of state descriptor 430A and a second plurality of state values of state descriptor 430B.

Reference is now made again to FIG. 3. Optionally, in 332 processing unit 101 fails to identify a conflict between one or more first entity values of entity descriptor 410A, and one or more second entity values of entity descriptor 410B, according to an outcome of applying the conflict test in 320.

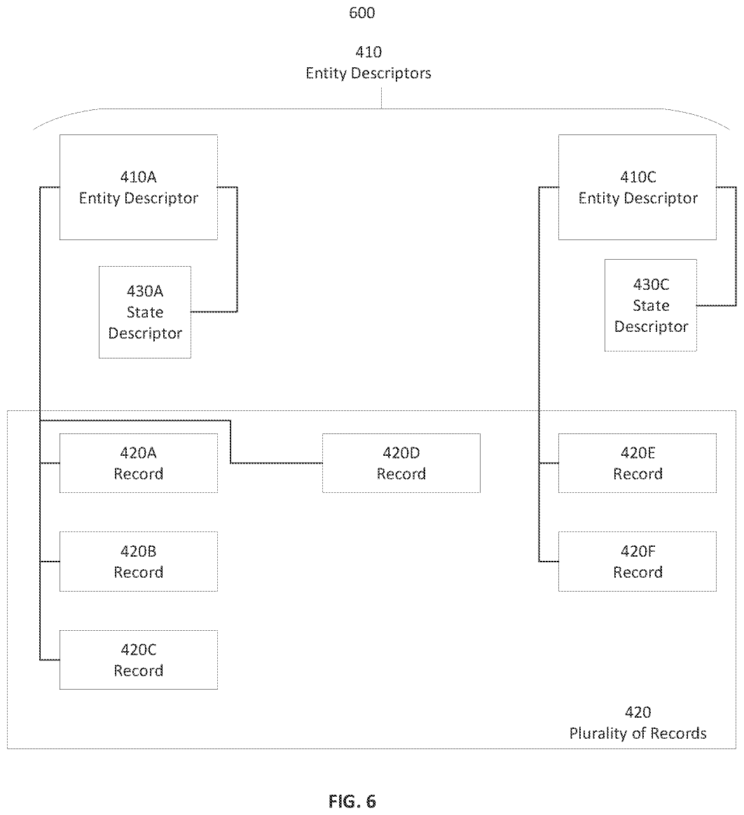

Subject to failing to identify the conflict, in 340 the processing unit 101 optionally merges entity descriptor 410A and entity descriptor 410B. Reference is now made also to FIG. 6, showing a schematic block diagram of an exemplary updated plurality of descriptors 600, according to some embodiments. Optionally, merging entity descriptor 410A with entity descriptor 410B comprises merging state descriptor 430A with state descriptor 430B. Optionally, the processing unit 101 merges state descriptor 430A with state descriptor 430B in 340, and merges entity descriptor 410A with entity descriptor 410B after executing the plurality of iterations to apply the plurality of rules 1010 to the plurality of record 120. Optionally, merging entity descriptor 410A with entity descriptor 410B comprises merging a first set of records associated with entity descriptor 410A with a second set of records associated with entity descriptor 410B. In this example, entity descriptor 410B is merged into entity descriptor 410A, state descriptor 430B is merged into state descriptor 410A and record 420D, associated with entity descriptor 410B is now associated with entity descriptor 410A.

Reference is now made again to FIG. 3. In 350, processing unit 101 optionally identifies if the rule should be applied to another pair of records of the plurality of records in another of the plurality of other iterations. In this example, in the other iteration of the plurality of iterations, the first record may be record 420A associated with descriptor 410A and describing entity 120A, and the second record may be record 420E associated with descriptor 410C and describing entity 120B. In this example, in the other iteration of the plurality of other iterations, in 320 the processing unit 101 applies the correlation test to the first plurality of record values of record 420A and to a third plurality of record values of record 420E. Optionally when executing 322 in the other iteration processing unit 101 identifies a correlation between entity 120A and entity 120B according to an outcome of applying the correlation test in 320. Optionally when executing 330 in the other iteration, the processing unit 101 applies the conflict test to the first plurality of entity values of entity descriptor 410A and to a third plurality of entity values of entity descriptor 410C. Optionally when executing 332 in the other iteration, the processing unit 101 identifies a conflict between first entity values of entity descriptor 410A, and one or more third entity values of entity descriptor 410C, according to an outcome of applying the conflict test in 320 in the other iteration. Optionally, subject to identifying the conflict, the processing unit declines to merge entity descriptor 410C with entity descriptor 410A.

According to some embodiments described here within, a conflict test describes a constraint on the plurality of entity values of an entity descriptor. For example, the conflict test may describe a constraint of the plurality of entity values of an entity descriptor having only one serial number value of a device, even when there is a correlation between MAC addresses. In this example, the correlation test comprises one or more values of a MAC address of a device and the conflict test comprises one or more other values of a serial number of a device.

In another example, the conflict test may describe a constraint of the plurality of entity values of the entity descriptor having only one cloud identifier of a device, even when there is a correlation between MAC addresses, and additionally or alternatively a correlation between host-names. In this example, the correlation test comprises one or more values of a MAC address of a device and one or more other values of a host-name of a device, and the conflict test comprises one or more yet other values of a cloud identifier of a device.

In yet another example, the conflict test may describe a constraint of the plurality of entity values of the entity descriptor having only one cloud identifier of a device, even when there is a correlation between UUIDs. In this example, the correlation test comprises one or more values of a UUID of a device, and the conflict test comprises one or more yet other values of a cloud identifier of a device.

In yet another example, the conflict test may describe a constraint of the plurality of entity values of the entity descriptor having only one value identifying a state of a user's address (one state identifier), even when there is a correlation between electronic mail addresses. In this example, the correlation test comprises one or more values of an electronic mail address of a user, and the conflict test comprises one or more yet other values of a state identifier.

In yet another example, the conflict test may describe a constraint of the plurality of entity values of the entity descriptor having only one user domain identification number of a user, even when there is a correlation between electronic mail addresses. In this example, the correlation test comprises one or more values of an electronic mail address of a user, and the conflict test comprises one or more yet other values of a user domain identification number of a user.

Optionally, the conflict test describes a constraint related to one or more value of the plurality of entity values of the entity descriptor that are used for correlation in the same rule. For example, the correlation test may comprise one or more identification values and the conflict test may comprise the same one or more identification values.

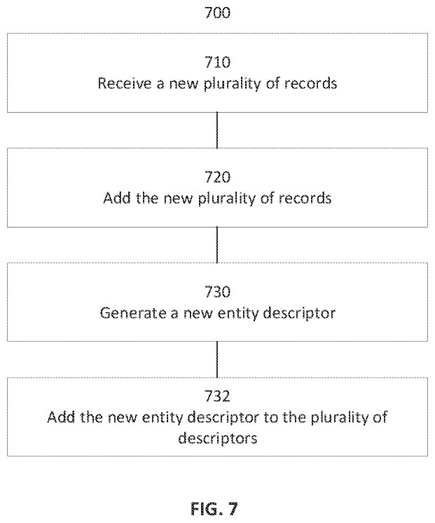

In some embodiments, processing unit 101 receives more than one plurality of records from the one or more system management entities. Reference is now made also to FIG. 7, showing a flowchart schematically representing another optional flow of operations 700 for generating an updated plurality of entity descriptors. In such embodiments, in 710 processing unit optionally receives a new plurality of records from the one or more system management entities. In 720, processing unit 101 optionally adds the new plurality of records to the plurality of records 120.

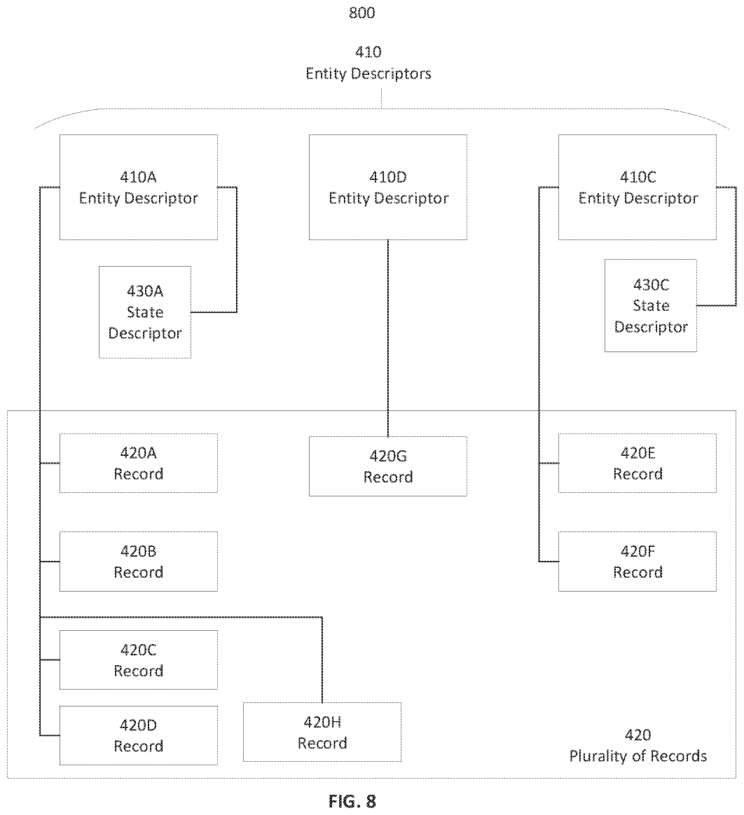

Reference is now made also to FIG. 8, showing a schematic block diagram of yet another exemplary plurality of descriptors 800, according to some embodiments. In this example, the new plurality of records comprises record 420H and record 420G. Optionally, record 420H is associated with entity descriptor 410A. Optionally, at least one of the new plurality of records is not associated with either entity descriptor 410A or entity descriptor 410C, in this example record 420G.

Reference is now made again to FIG. 7. Optionally, in 730 the processing unit 101 generates a new entity descriptor associated with record 420G. Reference is now made again to FIG. 8. In this example, entity descriptor 410D is the new entity descriptor associated with record 420G. Referring again to FIG. 7, in 432 processing unit 101 optionally adds new entity descriptor 410D to the plurality of entity descriptors 410.

Optionally, processing unit 101 executes method 300 more than once. When executing method 300 after receiving the new plurality of records, the plurality of records identified in 301 optionally comprises record 420G and record 420H. This allows checking correlations between entity descriptor 410D and other entity descriptors in plurality of entity descriptors 120.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant entity descriptors will be developed and the scope of the term “entity descriptor” is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, various embodiments may be presented in a range format. It should be understood that the description in range format is merely for convenience and brevity and should not be construed as an inflexible limitation on the scope of embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of embodiments, which are, for clarity, described in the context of separate embodiments, may also be provided in combination in a single embodiment. Conversely, various features of embodiments, which are, for brevity, described in the context of a single embodiment, may also be provided separately or in any suitable subcombination or as suitable in any other described embodiment. Certain features described in the context of various embodiments are not to be considered essential features of those embodiments, unless the embodiment is inoperative without those elements.

Although embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A method for managing a plurality of entities of a computerized system, comprising:
generating from a plurality of entity descriptors, each describing one of a plurality of entities of a computerized system, an updated plurality of entity descriptors, by:
identifying in the plurality of entity descriptors a plurality of records retrieved via at least one digital communication network interface from at least one system management entity managing the computerized system, each record describing an entity of the plurality of entities and associated with one of the plurality of entity descriptors describing the entity; and
applying to the plurality of records a plurality of rules organized in a prioritized set of rule sets, by in each of a plurality of iterations applying to the plurality of records a rule of a rule set of the prioritized set of rule sets in descending order of priority of the prioritized set of rule sets, wherein the prioritized set of rule sets enables application of one or more constraints that apply to an entire rule set when correlating one or more entity descriptors of the plurality of entity descriptors in descending order of priority, where in at least one iteration of the plurality of iterations the rule comprises a correlation test and a conflict test and applying the rule in the at least one iteration comprises, for a first record of the plurality of records, describing a first entity of the plurality of entities, and a second record of the plurality of records, describing a second entity of the plurality of entities:
identifying an equivalence between the first entity and the second entity when an outcome of applying the correlation test of the rule to a first plurality of values of the first record and a second plurality of values of the second record indicates that a media access control (MAC) address of a first device of a plurality of devices of the computerized system is equal to a second MAC address of a second device of the plurality of devices and where applying the correlation test of the rule comprises applying the correlation test of the rule to the first MAC address and the second MAC address;
identifying a conflict between at least one first entity value of a first entity descriptor associated with the first record and at least one second entity value of a second entity descriptor associated with the second record when another outcome of applying the conflict test of the rule to a first plurality of entity values of the first entity descriptor and a second plurality of entity values of the second entity descriptor indicates at least one of:
a first serial number of the first device is different from a second serial number of the second device, where the first plurality of entity values comprises the first serial number and the second plurality of entity values comprises the second serial number and where applying the conflict test of the rule comprises applying the conflict test of the rule to the first serial number and the second serial number; and
a first cloud identifier of the first device is different from a second cloud identifier of the second device, where the first plurality of entity values comprises the first cloud identifier and the second plurality of entity values comprises the second cloud identifier and where applying the conflict test of the rule comprises applying the conflict test of the rule to the first cloud identifier and the second cloud identifier; and
subject to failing to identify the conflict, merging the first entity descriptor and the second entity descriptor, otherwise declining to perform the merge; and
performing at least one management operation on at least one of the plurality of entities using the updated plurality of entity descriptors.

2. The method of claim 1, wherein the first entity descriptor has a first state descriptor associated therewith, comprising a first plurality of state values that are members of the first plurality of entity values;
wherein the second entity descriptor has a second state descriptor associated therewith, comprising a second plurality of state values that are members of the second plurality of entity values; and
wherein applying the conflict test of the rule to the first plurality of entity values and the second plurality of values is by applying the conflict test of the rule to the first plurality of state values and the second plurality of state values.

3. The method of claim 2, wherein merging the first entity descriptor and the second entity descriptor comprises merging the first state descriptor and the second state descriptor.

4. The method of claim 1, further comprising:
receiving a new plurality of records from the at least one system management entity;
adding the new plurality of records to the plurality of records; and
for at least one new record of the new plurality of records:
generating a new entity descriptor, associated with the at least one new record; and
adding the new entity descriptor to the plurality of entity descriptors.

5. The method of claim 1, wherein applying the rule to the plurality of records comprises:
in each of a plurality of other iterations:
selecting another first record and another second record from the plurality of records;
computing a first outcome value by applying the correlation test of the rule to another first plurality of values of the first record and another second plurality of values of the second record; and
subject to identifying the equivalence between the first entity and the second entity, computing a second outcome value by applying the conflict test of the rule to another first plurality of entity values of another first entity descriptor associated with the other first record and another second plurality of entity values of another second entity descriptor associated with the other second record.

6. The method of claim 1, wherein each of the plurality of entity descriptors comprises a plurality of entity values, each for one of a plurality of entity attributes;
wherein the first plurality of entity values are at least some of the plurality of entity values of the first entity descriptor;
wherein the second plurality of entity values are at least some of the plurality of entity values of the second entity descriptor;
wherein each of the plurality of records comprises a plurality of record values, each for one of the plurality of entity attributes;
wherein the first plurality of values are at least some of the plurality of record values of the first record; and
wherein the second plurality of values are at least some of the plurality of record values of the second records.

7. The method of claim 6, wherein the plurality of entities comprises a plurality of devices; and
wherein the plurality of entity attributes comprises at least one of: a serial number of a device of the plurality of devices, a host-name of a device of the plurality of devices, a media access control (MAC) address of a device of the plurality of devices, an internet protocol (IP) address of a device of the plurality of devices, a cloud identifier of a device of the plurality of devices, a universally unique identifier (UUID) of a device of the plurality of devices, and an operating system of a device of the plurality of devices.

8. The method of claim 7, wherein the correlation test comprises at least one value of a MAC address of a device and the conflict test comprises at least one other value of a serial number of a device.

9. The method of claim 7, wherein the correlation test comprises at least one first value of a MAC address of a device and at least one second value of a host-name of a device, and the conflict test comprises at least one third value of a cloud identifier of a device.

10. The method of claim 7, wherein the correlation test comprises at least one value of a UUID of a device and the conflict test comprises at least one other value of a cloud identifier of a device.

11. The method of claim 6, wherein the plurality of entities comprises a plurality of users; and
wherein the plurality of entity attributes comprises at least one of: a username of a user of the plurality of users, an electronic mail address of a user of the plurality of users, a state identifier of a user of the plurality of users, a user domain identification number of a user of the plurality of users, and an employee identification number of a user of the plurality of users.

12. The method of claim 11, wherein the correlation test comprises at least one value of an electronic mail address of a user and the conflict test comprises at least one other value of a state identifier of a user.

13. The method of claim 11, wherein the correlation test comprises at least one value of an electronic mail address of a user and the conflict test comprises at least one other value of a user domain identification number of a user.

14. The method of claim 1, wherein the at least one management operation comprises at least one of: installing an operating system update on one of the plurality of entities, and instructing execution of a management query by one of the plurality of entities.

15. A system for managing a plurality of entities of a computerized system, comprising:
at least one digital communication network interface; and
at least one hardware processor connected to the at least one digital communication network interface and configured to:
generate from a plurality of entity descriptors, each describing one of a plurality of entities of a computerized system, an updated plurality of entity descriptors, by:
identifying in the plurality of entity descriptors a plurality of records retrieved via the at least one digital communication network interface from at least one system management entity managing the computerized system, each record describing an entity of the plurality of entities and associated with one of the plurality of entity descriptors describing the entity; and
applying to the plurality of records a plurality of rules organized in a prioritized set of rule sets, by in each of a plurality of iterations applying to the plurality of records a rule of a rule set of the prioritized set of rule sets in descending order of priority of the prioritized set of rule sets, wherein the prioritized set of rule sets enables application of one or more constraints that apply to an entire rule set when correlating one or more entity descriptors of the plurality of entity descriptors in descending order of priority, where in at least one iteration of the plurality of iterations the rule comprises a correlation test and a conflict test and applying the rule in the at least one iteration comprises, for a first record of the plurality of records, describing a first entity of the plurality of entities, and a second record of the plurality of records, describing a second entity of the plurality of entities:
identifying an equivalence between the first entity and the second entity when an outcome of applying the correlation test of the rule to a first plurality of values of the first record and a second plurality of values of the second record indicates that a media access control (MAC) address of a first device of a plurality of devices of the computerized system is equal to a second MAC address of a second device of the plurality of devices and where applying the correlation test of the rule comprises applying the correlation test of the rule to the first MAC address and the second MAC address;
identifying a conflict between at least one first entity value of a first entity descriptor associated with the first record and at least one second entity value of a second entity descriptor associated with the second record when another outcome of applying the conflict test of the rule to a first plurality of entity values of the first entity descriptor and a second plurality of entity values of the second entity descriptor indicates at least one of:
a first serial number of the first device is different from a second serial number of the second device, where the first plurality of entity values comprises the first serial number and the second plurality of entity values comprises the second serial number and where applying the conflict test of the rule comprises applying the conflict test of the rule to the first serial number and the second serial number; and
a first cloud identifier of the first device is different from a second cloud identifier of the second device, where the first plurality of entity values comprises the first cloud identifier and the second plurality of entity values comprises the second cloud identifier and where applying the conflict test of the rule comprises applying the conflict test of the rule to the first cloud identifier and the second cloud identifier; and
subject to failing to identify the conflict, merging the first entity descriptor and the second entity descriptor, otherwise declining to perform the merge; and
perform at least one management operation on at least one of the plurality of entities using the updated plurality of entity descriptors.

16. (canceled)

17. The system of claim 15, wherein the at least one system management entity comprises at least one other hardware processor configured to manage the computerized system in at least one management domain; and
wherein the at least one hardware processor is further configured to receive at least some of the plurality of records from the at least one other hardware processor.

18. The system of claim 15, further comprising a non-volatile digital storage connected to the at least one hardware processor;
wherein the at least one hardware processor is further configured to retrieve at least some of the plurality of records from the non-volatile digital storage.

19. A software program product for managing a plurality of entities of a computerized system, comprising:
a non-transitory computer readable storage medium;
first program instructions for generating from a plurality of entity descriptors, each describing one of a plurality of entities of a computerized system, an updated plurality of entity descriptors, by: identifying in the plurality of entity descriptors a plurality of records retrieved via at least one digital communication network interface from at least one system management entity managing the computerized system, each record describing an entity of the plurality of entities and associated with one of the plurality of entity descriptors describing the entity; and applying to the plurality of records a plurality of rules organized in a prioritized set of rule sets, by in each of a plurality of iterations applying to the plurality of records a rule of a rule set of the prioritized set of rule sets in descending order of priority of the prioritized set of rule sets, wherein the prioritized set of rule sets enables application of one or more constraints that apply to an entire rule set when correlating one or more entity descriptors of the plurality of entity descriptors in descending order of priority, where in at least one iteration of the plurality of iterations the rule comprises a correlation test and a conflict test and applying the rule in the at least one iteration comprises, for a first record of the plurality of records, describing a first entity of the plurality of entities, and a second record of the plurality of records, describing a second entity of the plurality of entities: identifying an equivalence between the first entity and the second entity when an outcome of applying the correlation test of the rule to a first plurality of values of the first record and a second plurality of values of the second record indicates that a media access control (MAC) address of a first device of a plurality of devices of the computerized system is equal to a second MAC address of a second device of the plurality of devices and where applying the correlation test of the rule comprises applying the correlation test of the rule to the first MAC address and the second MAC address; identifying a conflict between at least one first entity value of a first entity descriptor associated with the first record and at least one second entity value of a second entity descriptor associated with the second record when another outcome of applying the conflict test of the rule to a first plurality of entity values of the first entity descriptor and a second plurality of entity values of the second entity descriptor indicates at least one of: a first serial number of the first device is different from a second serial number of the second device, where the first plurality of entity values comprises the first serial number and the second plurality of entity values comprises the second serial number and where applying the conflict test of the rule comprises applying the conflict test of the rule to the first serial number and the second serial number; and a first cloud identifier of the first device is different from a second cloud identifier of the second device, where the first plurality of entity values comprises the first cloud identifier and the second plurality of entity values comprises the second cloud identifier and where applying the conflict test of the rule comprises applying the conflict test of the rule to the first cloud identifier and the second cloud identifier; and subject to failing to identify the conflict, merging the first entity descriptor and the second entity descriptor, otherwise declining to perform the merge; and
second program instructions for performing at least one management operation on at least one of the plurality of entities using the updated plurality of entity descriptors;
wherein the first and second program instructions are executed by at least one computerized processor from the non-transitory computer readable storage medium.
